(19) United States
(12) Patent Application Publication
(10) Pub. No.: US 2014/0244846 A1
(43) Pub. Date: Aug. 28, 2014

(54) INFORMATION PROCESSING APPARATUS, RESOURCE CONTROL METHOD, AND PROGRAM

(71) Applicant: SONY CORPORATION, Tokyo (JP)

(72) Inventors: Mitsuru Takehara, Tokyo (JP); Yuichi Kageyama, Tokyo (JP); Yoshiki Tanaka, Kanagawa (JP); Hisahiro Suganuma, Tokyo (JP)

(73) Assignee: SONY CORPORATION, Tokyo (JP)

(21) Appl. No.: 14/179,114

(22) Filed: Feb. 12, 2014

(30) Foreign Application Priority Data
Feb. 22, 2013 (JP) 2013-033451

(51) Int. Cl. H04L 12/911

(52) U.S. Cl. CPC H04L 47/70
USPC 709/226

(57) ABSTRACT

There is provided an information processing apparatus including a determination unit that determines whether to change a number of processes allocated to one or more program modules, based on a measurement result of a load of each program module when the program modules that form an application are executed using scalable processing resources.

### CROSS REFERENCE TO RELATED APPLICATIONS

This application claims the benefit of Japanese Priority Patent Application JP 2013-033451 filed Feb. 22, 2013, the entire contents of which are incorporated herein by reference.

### BACKGROUND

The present disclosure relates to an information processing apparatus, a resource control method, and a program.

In recent years, computer use forms called cloud computing have been widely utilized. According to a definition by the National Institute of Standards and Technology, cloud computing is a model for enabling convenient, on-demand network access to a shared pool of configurable computing resources and a model for allocating and providing resources rapidly with minimal use procedures or minimal interactions with a service provider.

One of the characteristics of cloud computing is to provide scalable resources and execute scale-in or scale-out of the resources rapidly or automatically in response to a request of a user or an application. In general, scale-in refers to reduction of the size (scale) of resources and scale-out refers to expansion of the size of resources. For example, “Auto Scaling,” [online] [searched on 28 Jan. 2013] Internet <URL: http://aws.amazon.com/en/autoscaling/> describes a method of automatically increasing an allocation number of instances of a physical or virtual application server when a load of a process is greater than a threshold value set in advance by a user. JP 2011-118525A discloses a method of executing scale-in or scale-out of a server based on a future load predicted using a history of the load of the server.

### SUMMARY

However, not only a processor but also various resources such as a memory, an input/output (I/O) device, and a communication device are associated with a server. In scale-in and scale-out in units of servers, it is difficult to use the resources without waste.

Accordingly, it is desirable to realize a structure capable of efficiently utilizing resources rather than rough resource control in units of servers.

According to an embodiment of the present disclosure, there is provided an information processing apparatus including a determination unit that determines whether to change a number of processes allocated to one or more program modules, based on a measurement result of a load of each program module when the program modules that form an application are executed using scalable processing resources.

According to an embodiment of the present disclosure, there is provided a resource control method executed by an information processing apparatus, the resource control method including determining whether to change a number of processes allocated to one or more program modules, based on a measurement result of a load of each program module when the program modules that form an application are executed using scalable processing resources.

According to an embodiment of the present disclosure, there is provided a program for causing a computer that controls an information processing apparatus to function as a determination unit that determines whether to change a number of processes allocated to one or more program modules, based on a measurement result of a load of each program module when the program modules that form an application are executed using scalable processing resources.

According to embodiments of a technology related to the present disclosure, it is possible to utilize computing resources more efficiently than resource control in units of servers.

### BRIEF DESCRIPTION OF THE DRAWINGS

FIG. 1 is an explanatory diagram for describing an overview of an information processing apparatus according to an embodiment;

FIG. 2A is a first explanatory diagram for describing an example of resource control in units of servers;

FIG. 2B is a second explanatory diagram for describing an example of resource control in units of servers;

FIG. 2C is a first explanatory diagram for describing an example of resource control in units of processes;

FIG. 2D is a second explanatory diagram for describing an example of resource control in units of processes;

FIG. 3 is a block diagram illustrating an example of the configuration of an information processing apparatus according to a first embodiment;

FIG. 4 is an explanatory diagram for describing an example of a method of measuring a load for each program module;

FIG. 5A is an explanatory diagram for describing a first example of allocation of the number of processors according to a ratio of load;

FIG. 5B is an explanatory diagram for describing a second example of allocation of the number of processors according to a ratio of load;

FIG. 6 is an explanatory diagram for describing another example of a method of measuring a load for each program module;

FIG. 7 is an explanatory diagram for describing still another example of a method of measuring a load for each program module;

FIG. 8 is an explanatory diagram for describing yet another example of a method of measuring a load for each program module;

FIG. 9 is a flowchart illustrating an example of flow of a resource control process executed in the first embodiment;

FIG. 10 is a flowchart illustrating an example of a detailed flow of a resource allocation determination process illustrated in FIG. 9;

FIG. 11 is a block diagram illustrating an example of the configuration of an information processing apparatus according to a second embodiment; and

FIG. 12 is an explanatory diagram for describing a resource model expressing a relation between the number of requests and a necessary scale of resources.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Introduction

2. First embodiment
2-1. Example of configuration of apparatus
2-2. Flow of processes

3. Second embodiment

4. Conclusion

### 1. Introduction

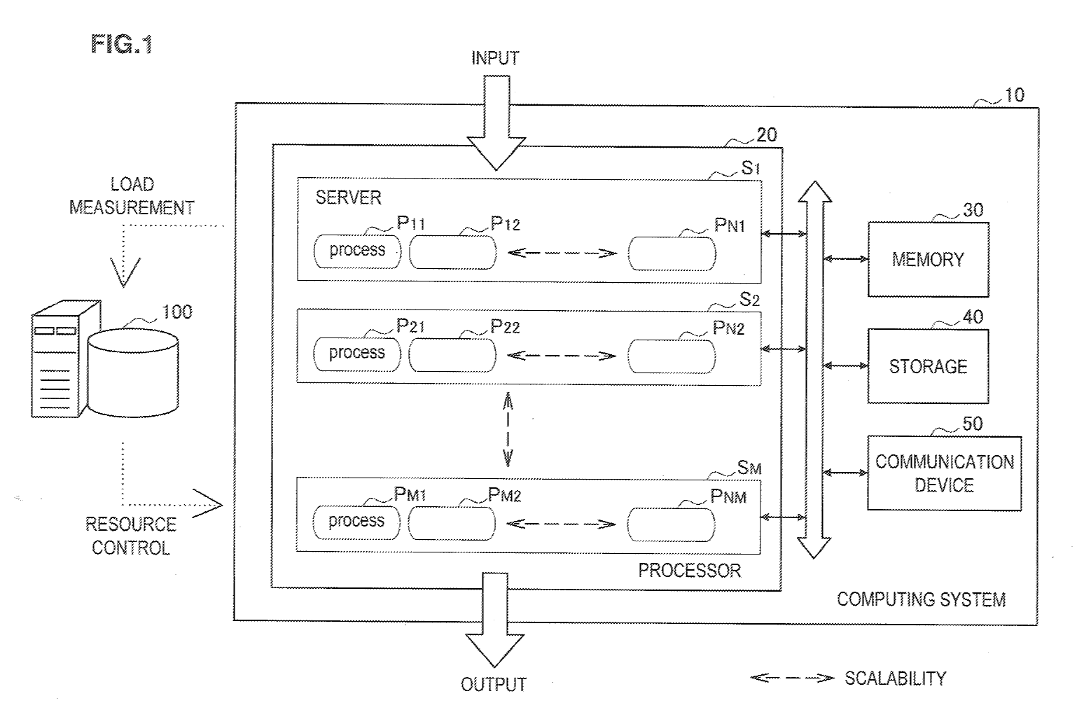

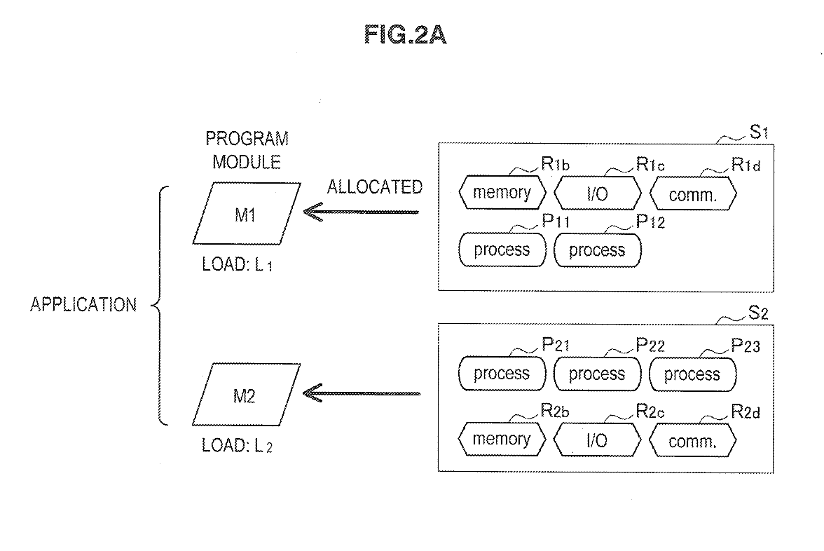

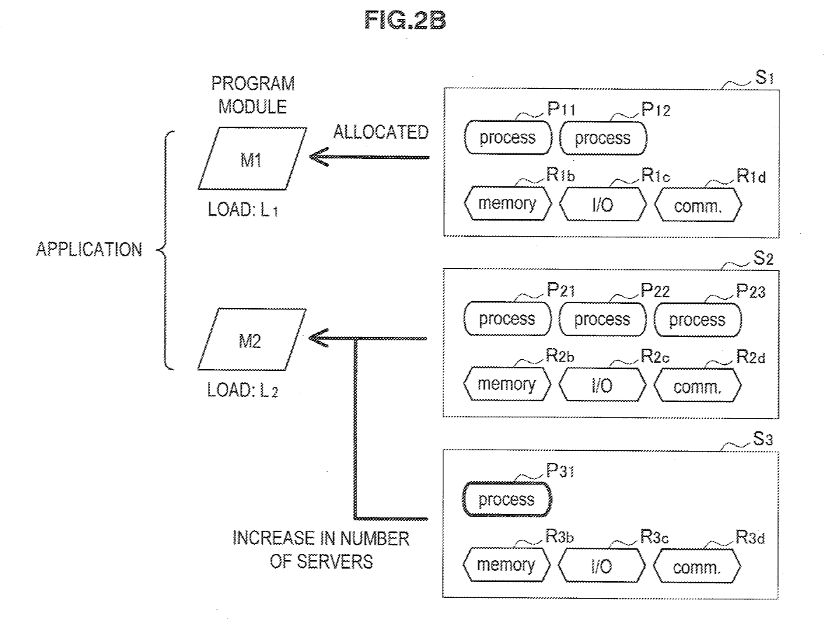

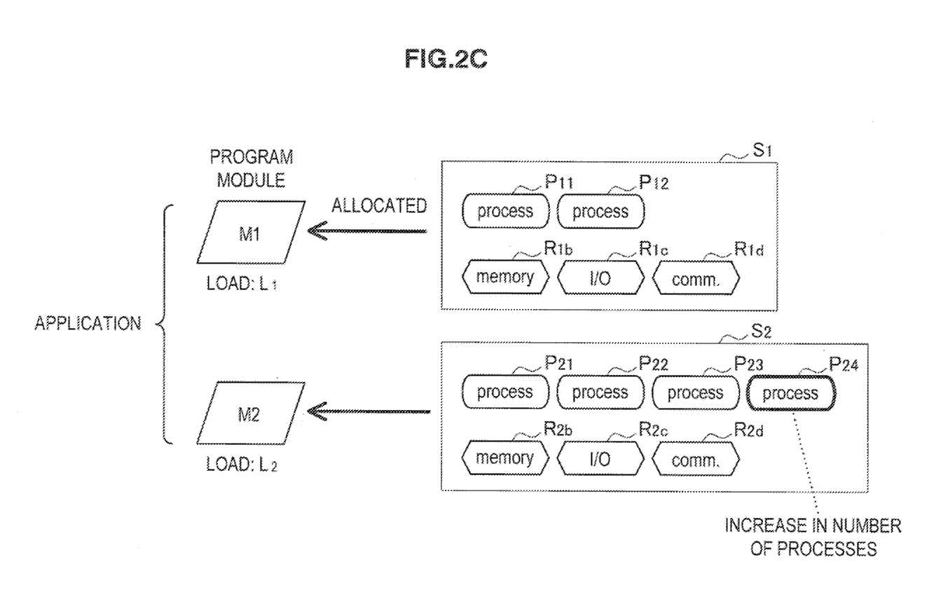

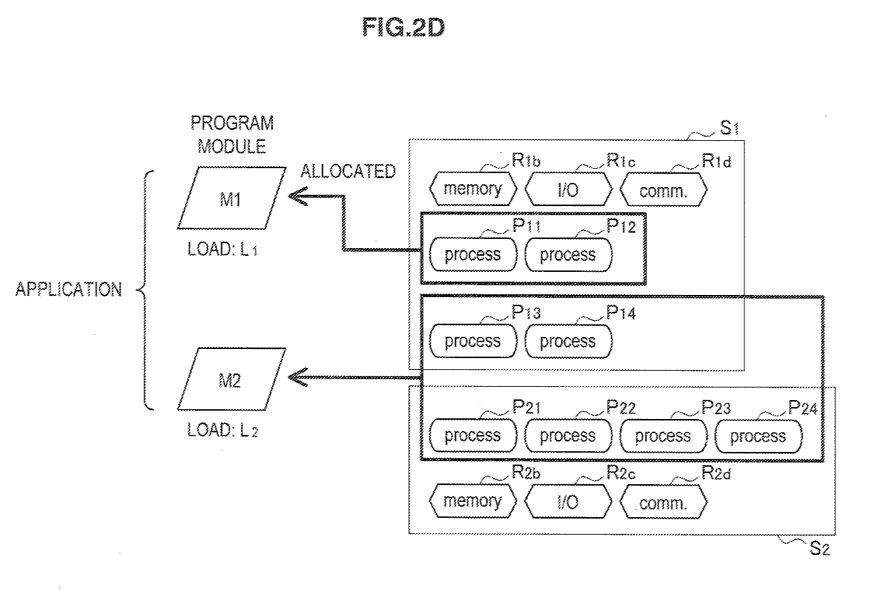

First, an introduction of an information processing apparatus according to an embodiment will be described with reference to FIGS. 1 to 2D.

FIG. 1 is an explanatory diagram for describing the overview of an information processing apparatus 100 according to an embodiment. Referring to FIG. 1, a computing system 10 and the information processing apparatus 100 that controls resources of the computing system 10 are illustrated.

The computing system 10 is a system that has resources used to execute an application. More specifically, the computing system 10 executes one or more program modules included in an application using scalable processing resources. In the example of FIG. 1, the computing system 10 includes a processor 20, a memory 30, a storage 40, and a communication device 50. The processor 20 may be, for example, a central processing unit (CPU) or a digital signal processor (DSP). The memory 30 includes a random access memory (RAM) and a read-only memory (ROM) and stores program codes executed by the processor 20. The storage 40 may be, for example, a large-capacity storage medium such as a hard disk and stores data to be input to each program module and data to be output from each program module. The communication device 50 relays communication between the computing system 10 and another apparatus. In practice, the computing system 10 may be one physical computer or a set of a plurality of physical computers.

In an existing cloud computing system, resources can be virtualized in units of servers. The number of virtual servers can be dynamically changed according to needs of a user or an application. In the example of FIG. 1, the computing system 10 includes M servers S₁, S₂, . . . , and S_{M}. Each of the servers S₁, S₂, . . . , and S_{M} allocates a part of memory space of the memory 30 and includes an interface with the storage 40 and an interface with the communication device 50.

Each of the servers S₁, S₂ . . . , and S_{M} includes one or more processes Pᵢⱼ (where i=1, 2, . . . , M and j=1, 2, . . . , and N_{M}) in order to realize more flexible scalability of resources. Here, Nᵢ is the number of processes of an i^{th} server. For example, in order to process so-called “big data” in real time, processing resources are managed with a hierarchical structure called servers and processes in a Storm framework suggested by the developers of Twitter (registered trademark). Storm is an example of a framework available to realize a technology related to an embodiment of a technology related to the present disclosure.

Here, although the processing resources are hierarchized to servers and processes, resources may be wasted when scale-in and scale-out of the resources are performed in units of servers as in the existing structure.

FIGS. 2A and 2B are explanatory diagrams for describing an example of resource control in units of servers. Referring to FIG. 2A, an application including program modules M1 and M2 is illustrated. For example, the server S₁ is allocated to the program module M1. The server S₁ includes processes P₁₁ and P₁₂, a memory space R_{1b}, an I/O interface R_{1c}, and a communication interface R_{1d}. The server S₂ is allocated to the program module M2. The server S₂ includes processes P₂₁, P₂₂, and P₂₃, a memory space R_{2b}, an I/O interface R_{2c}, and a communication interface R_{2d}.

A load L₁ is a load measured for the program module M1. A load L₂ is a load measured for the program module M2. Here, for example, when an increase in process requests to an application is detected or predicted and it is desirable to avoid an increase in the load L₂, the scale-out in units of servers for the program module M2 can be performed. Referring to FIG. 2B, a server S₃ is newly allocated to the program module M2. The server S₃ includes process P₃₁, a memory space R_{3b}, an I/O interface R_{3c}, and a communication interface R_{3d}. However, there are various causes increasing the load L₂. For example, when the program module M2 is characterized as performing a plurality of calculations or a complicated calculation, a lack of processing resources may be a main cause increasing the load L₂. On the other hand, when the program module M2 is characterized as reading or writing a large amount of data, a lack of memory resources or a long waiting time for I/O without a lack of the processing resources may be a main cause increasing the load L₂. In the latter case, scale-out in units of servers for an increase in the number of physical or virtual servers may be an effective countermeasure. In the former case, however, the increase in the number of physical or virtual servers may consequently cause waste of a memory space and an I/O interface.

Accordingly, in an embodiment of a technology related to the present disclosure, the information processing apparatus 100 is introduced to control resources to be allocated to respective program modules in units of processes. The information processing apparatus 100 adjusts a load so that a desired performance (a throughput, a delay time, or the like) of an application is satisfied, while efficiently using resources of the computing system 10 by controlling resources to be allocated to respective program modules in units of processes.

FIGS. 2C and 2D are explanatory diagrams for describing an example of resource control in units of processes. Referring to FIG. 2C, the application including the program modules M1 and M2 illustrated in FIG. 2A is illustrated again. The number of servers allocated to the program module M2 remains at one and a process P₂₄ inside the server S2 is newly allocated to the program module M2. Scale-out in units of processes enables suppression of the load without causing waste of a memory space and an I/O interface with regard to a program module characterized as performing a plurality of calculations or a complicated calculation.

An embodiment of the present disclosure is not limited to the examples of FIGS. 2A to 2C, one server may be allocated to a plurality of program modules. Referring to FIG. 2D, the server S₁ includes the processes P₁₁, P₁₂, P₁₃, and P₁₄, the memory space R_{1b}, the I/O interface R_{1c}, and the communication interface R_{1d}. The server S₂ includes the processes P₂₁, P₂₂, P₂₃, and P₂₄, the memory space R_{2b}, the I/O interface R_{2c}, and the communication interface R_{2d}. The processes P₁₁ and P₁₂ of the server S₁ are allocated to the program module M1. The processes P₁₃ and P₁₄ of the server S₁ and the processes P₂₁, P₂₂, P₂₃, and P₂₄ of the server S₂ are allocated to the program module M2. Even in this case, the information processing apparatus 100 can control the resources to be allocated to the program modules M1 and M2 in units of processes.

### 2. First Embodiment

The information processing apparatus 100 may be mounted as a part of a service by a service provider who operates a cloud computing service. Instead, the information processing apparatus 100 may be mounted by a user who uses a cloud computing service. A technology related to an embodiment of the present disclosure can also be applied to a service of a form which is not necessarily expressed with the term “cloud computing.” The information processing apparatus 100 may be, for example, a general-purpose personal computer (PC) or workstation or may be a dedicated apparatus that is designed for the unique purpose of controlling resources.

### [2-1. Example of Configuration of Apparatus]

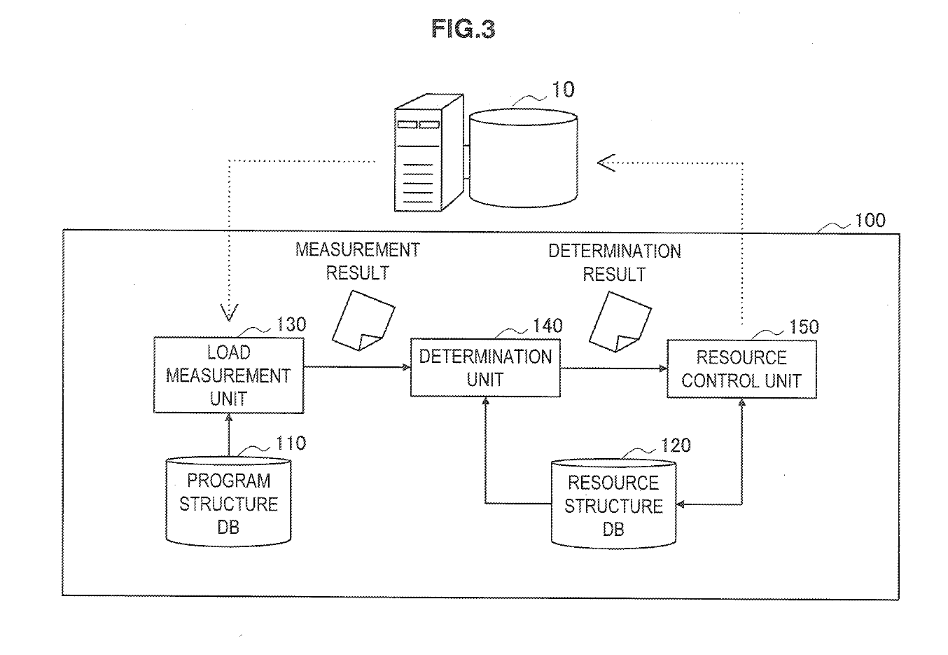

FIG. 3 is a block diagram illustrating an example of the configuration of the information processing apparatus 100 according to a first embodiment. Referring to FIG. 3, the information processing apparatus 100 includes a program structure DB 110, a resource structure DB 120, a load measurement unit 130, a determination unit 140, and a resource control unit 150.

### (1) Program Structure DB

The program structure DB 110 is a database that stores program structure data indicating a program structure of one or more applications executed by the computing system 10. The program structure data indicates a list of one or more program modules included in each application and a calling relation between the program modules. Also, the program structure data includes information used to identify input data and output data of each program module. The program structure data may automatically be generated by analyzing an application or may be generated by a user who develops an application. Several examples of typical program structures will be described in detail later.

### (2) Resource Structure DB

The resource structure DB 120 is a database that stores resource structure data indicating the structure of resources allocated to each program module of an application that is being executed by the computing system 10. The processing resources of the computing system 10 are resources for which an allocation scale can be changed dynamically, that is, scalable resources, as described above. For example, the resource structure data indicates the number of allocated servers and the number of allocated processes of each server according to the program module. When the allocation of the resources is changed by the resource control unit 150 to be described below, the resource structure data stored by the resource structure DB 120 is updated so that the change is reflected.

### (3) Load Measurement Unit

The load measurement unit 130 measures a load of each of the program modules included in an application which is being executed by the computing system 10. Loads measured by the load measurement unit 130 in the embodiment include a computational load of each program module and a non-computational load of each server. For example, the non-computational load includes at least one of a memory load (memory use ratio or the like), an I/O load (an I/O number per unit time, an I/O waiting time or the like), and a communication load (a communication data amount per unit time, a communication waiting time, or the like). The computational load is typically a load applied to a processor. However, in many cloud computing environments, it is difficult to directly measure how many loads are applied to which processor when a certain program module is executed. Accordingly, in the embodiment, the load measurement unit 130 measures the number of pieces of input data during processing for each program module as the computational load. The amount of input data during processing can be computed by subtracting the amount of output data from the amount of input data of each program module. In a cloud computing environment, a file system installed in a storage can be monitored even though processing resources are highly virtualized. Accordingly, by adopting a method of guiding the computational load approximately using the amount of input data and the amount of output data on a file system, the computational load of each program module can be identified without necessity of systematic alternation of the cloud computing environment.

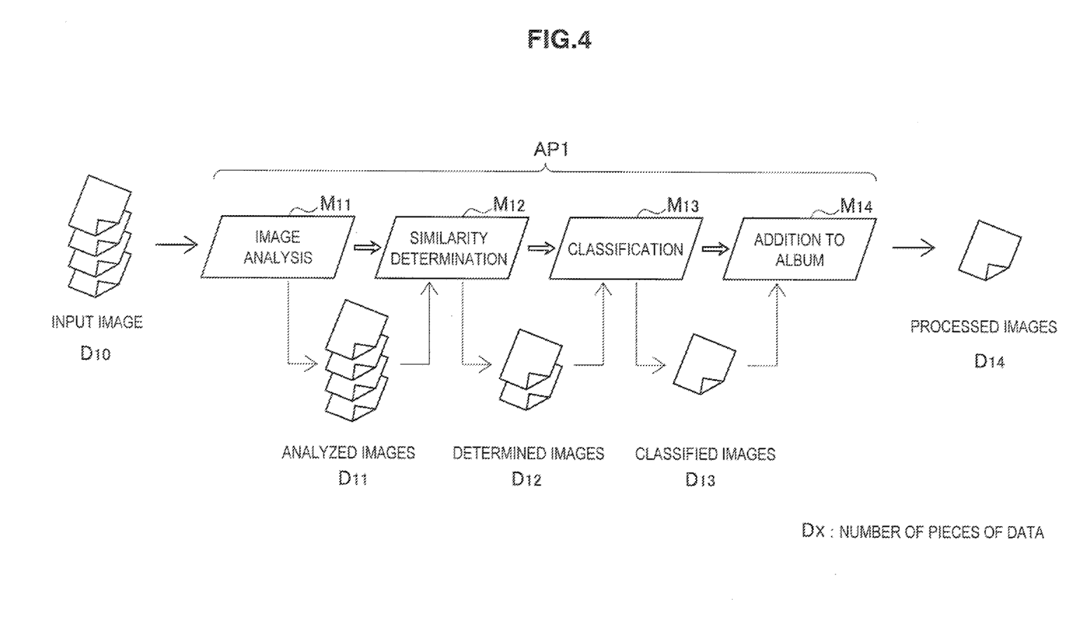

FIG. 4 is an explanatory diagram for describing an example of a method of measuring a load of each program module. Referring to FIG. 4, four program modules M₁₁, M₁₂, M₁₃, and M₁₄ included in an application AP1 are illustrated. For example, the application AP1 is an image processing application for automatically adding input images (for example, photos imaged by an end user) to image albums. The program module M₁₁ extracts image feature amounts by analyzing the features of the input images. The program module M₁₂ compares the extracted feature amounts to the feature amounts of other images and determines similarity between the images. The program module M₁₃ classifies the input images to one of a plurality of groups (or a new group) according to the determined similarity. The program module M₁₄ adds each input image to the album of the group to which the input images are classified. As illustrated in FIG. 4, the program modules M₁₁, M₁₂, M₁₃, and M₁₄ have a simple sequential calling relation. That is, the program module M₁₁ receives input images as input data, outputs image feature amounts, and changes the statuses of the input images to the analyzed images. The number D₁₀ of input images and the number D₁₁ of analyzed images are the same as the number of pieces of input data and the number of pieces of output data of the program module M₁₁, respectively. The program module M₁₂ receives the image feature amounts as input data, outputs a set of the similarity as the result of the similarity determination, and changes the status of the analyzed images to the determined images. The number D₁₁ of analyzed images and the number D₁₂ of determined images are the same as the number of pieces of input data and the number of pieces of output data of the program module M₁₂, respectively. The program module M₁₃ receives the set of the similarity as input data, outputs the classification result (for example, an identifier of the group to which each input image belongs), and changes the statuses of the determined images to the classified images. The number D₁₂ of determined images and the number D₁₃ of classified images are the same as the number of pieces of input data and the number of pieces of output data of the program module M₁₃, respectively. The program module M₁₄ receives the result of the classification as input data, adds the input images to the corresponding albums, and changes the statuses of the classified images to the processed images. The number D₁₃ of classified images and the number D₁₄ of processed images are the same as the number of pieces of input data and the number of pieces of output data of the program module M₁₄, respectively. The load measurement unit 130 can measure loads L₁₁, L₁₂, L₁₃, and L₁₄ of the program modules M₁₁, M₁₂, M₁₃, and M₁₄ based on the numbers D₁₁ to D₁₄ of pieces of the input and output data as follows.

[Math. 1]

L₁₁=D₁₁−D₁₀ (1)

L₁₂=D₁₂−D₁₁ (2)

L₁₃=D₁₃−D₁₂ (3)

L₁₄=D₁₄−D₁₃ (4)

The load measurement unit 130 periodically measures the computational loads while executing an application. Also, the load measurement unit 130 periodically measures the non-computational loads while executing the application. The load measurement unit 130 outputs the values of the measured computational loads and the non-computational loads to the determination unit 140. The application described with reference to FIG. 4 is merely an example. A technology related to an embodiment of the present disclosure may be applied to a kind of application different from the example illustrated in FIG. 4.

### (4) Determination Unit

The determination unit 140 determines whether the number of processes allocated to each program module is changed based on the result of the measurement of the load of each program module input from the load measurement unit 130. For example, when the load measured for a given program module is greater than a threshold value definable in advance, the determination unit 140 may determine that the number of processes allocated to this program module is increased. Also, when the load measured for a program module is less than (the same or a different) threshold value definable in advance, the determination unit 140 may determine that the number of processes allocated to this program module is decreased.

In the embodiment, the determination unit 140 further determines whether the number of servers allocated to each program module is changed based on the non-computational load measured for each server. For example, when the determination unit 140 determines that the number of processes allocated to a given program module is increased and the non-computational load is greater than a threshold value definable in advance, the determination unit 140 can determine that the number of servers allocated to this program module is increased. By introducing this determination, the load can be resolved or reduced by dynamically increasing the number of servers when the non-computational load is a main cause of the overall load. Also, when the determination unit 140 determines that the number of processes allocated to a given program module is increased and the non-computational load is less than the threshold value, the determination unit 140 can determine that the number of processes allocated to this program module is increased while the number of servers allocated to this program module remains. By introducing this determination, the load can be resolved or reduced by dynamically increasing the number of processes without unnecessary addition of resources not contributing to the load, when the computational load is a main cause of the overall load. Likewise, when the determination unit 140 determines that the number of processes allocated to a given program module is reduced, the determination unit 140 may determine whether the number of servers allocated to this program module is reduced based on comparison between the non-computational load and a threshold value.

The determination unit 140 outputs the result of such determination based on the measurement result of the load to the resource control unit 150.

### (5) Resource Control Unit

The resource control unit 150 changes the allocation of the number of processes for the program module for which the number of allocated processes is determined to be changed by the determination unit 140. For example, the resource control unit 150 may simply add 1 to the number of allocated processes for the program module for which the number of processes is determined to be increased. Instead, the resource control unit 150 may increase the number of processes by a number different according to the size of the load at that time. Accordingly, when the load is not reduced, the number of processes can be further increased in a subsequent control period. Likewise, the resource control unit 150 may simply reduce 1 from the number of allocated processes for the program module for which the number of processes is determined to be decreased. Instead, the resource control unit 150 may decrease the number of processes by a number different according to the size of the load at that time. The resource control unit 150 can change the allocation of the number of servers for the program module for which the number of allocated servers is determined to be changed. When such resource control is repeated, a greater number of processes is consequently allocated to the program module indicating a high ratio of the number of pieces of input data which is being processed.

When the number of processes or the allocation of the number of processes and the number of servers is changed for a given program module, the resource control unit 150 changes the resource structure of the computing system 10 by transmitting a control signal to the computing system 10. Also, the resource control unit 150 also updates the resource structure data stored by the resource structure DB 120.

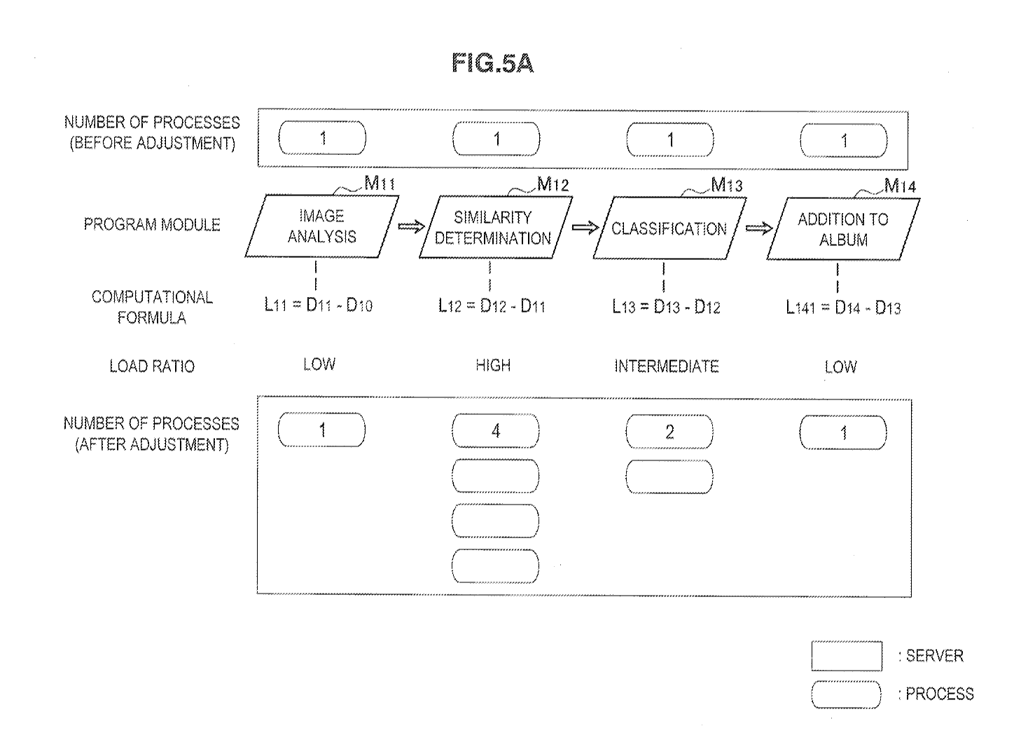

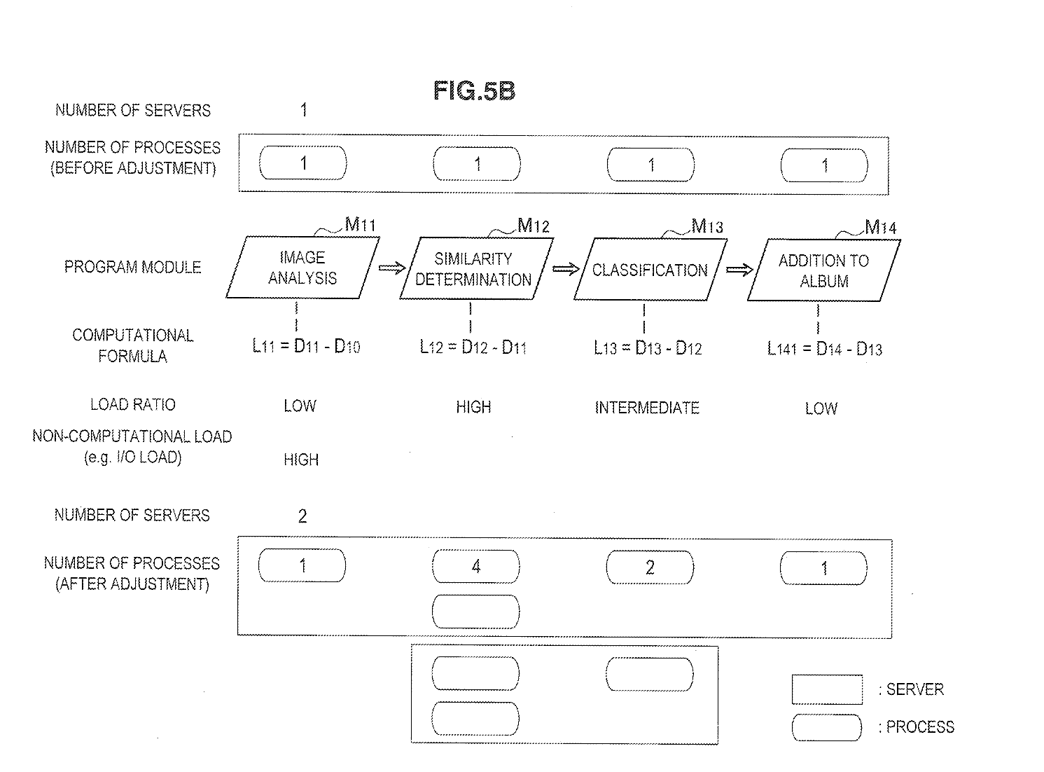

FIG. 5A is an explanatory diagram for describing a first example of the allocation of the number of processes according to a load ratio. In the example of FIG. 5A, one common server and one process are allocated to each of the program modules M₁₁, M₁₂, M₁₃, and M₁₄ in the beginning. The determination unit 140 measures the loads L₁₁, L₁₂, L₁₃, and L₁₄ of the program modules according to, for example, the above-described formulas (1) to (4). In the measurement result, the program module M₁₂ is assumed to have the highest load ratio and the program module M₁₃ is assumed to have the second highest load ratio (L₁₂>L₁₃>L₁₁, L₁₄). Then, when one or more control periods pass, the resource control unit 150 increases the number of processes allocated to the program module M₁₂ to 4 and increases the number of processes allocated to the program module M₁₃ to 2. Accordingly, by allowing the balance of the resources to be proper between the program modules M₁₁, M₁₂, M₁₃, and M₁₄, it is possible to ensure desired performance of the application. Also, in the example of FIG. 5A, the number of servers remains.

FIG. 5B is an explanatory diagram for describing a second example of the allocation of the number of processes according to the load ratio. In the example of FIG. 5B, one common server and one process are also allocated to each of the program modules M₁₁, M₁₂, M₁₃, and M₁₄ in the beginning. The determination unit 140 measures the loads L₁₁, L₁₂, L₁₃, and L₁₄ of the program modules according to, for example, the above-described formulas (1) to (4). In the measurement result, the program module M₁₂ is assumed to have the highest load ratio and the program module M₁₃ is assumed to have the second highest load ratio (L₁₂>L₁₃>L₁₁, L₁₄). Also, the non-computational load is assumed to indicate a high value. Then, when one or more control periods pass, the resource control unit 150 increases the number of servers to 2. Also, the resource control unit 150 increases the number of processes allocated to the program module M₁₂ to 4 (2 for each server) and increases the number of processes allocated to the program module M₁₃ to 2 (1 for each server). Accordingly, by allowing the balance of the resources to be proper between the program modules, it is possible to reinforce the resources other than the processing resources and ensure desired performance of the application.

### (6) Another Example of Load Measurement

The example of the method of measuring the load of each of the program modules having the simple sequential calling relation has been described in FIG. 4. In this section, a method of measuring loads in several cases in which the program modules have a more complicated calling relation will also be described.

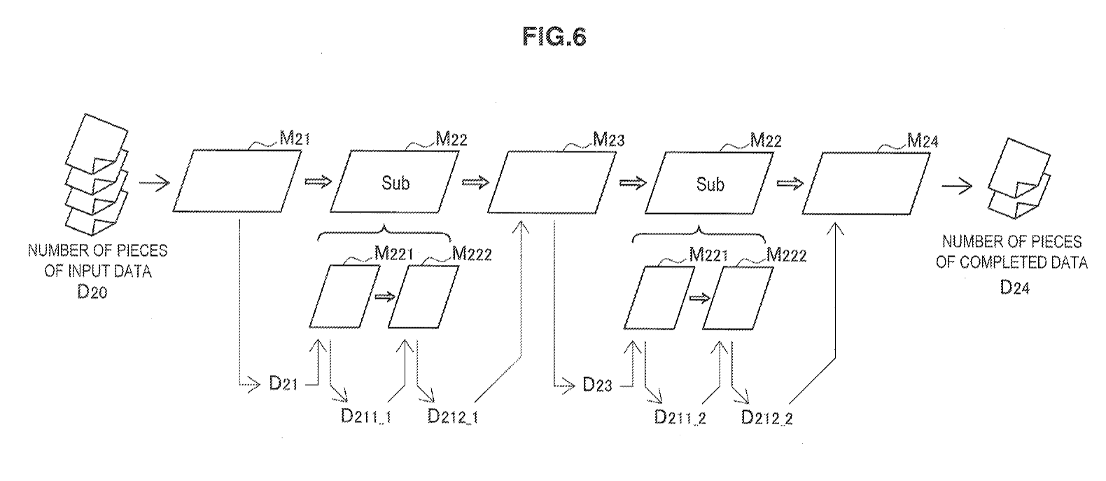

FIG. 6 is an explanatory diagram for describing another example of the method of measuring the load of each program module. Referring to FIG. 6, four program modules M₂₁, M₂₂, M₂₃, and M₂₄ included in a given application are illustrated. The program module M₂₂ has sub-routines M₂₂₁ and M₂₂₂ and is called twice with regard to one piece of input data. The number of pieces of input data and the number of pieces of output data of the program module M₂₁ are D₂₀ and D₂₁, respectively. The number of pieces of input data and the number of pieces of output data in the first execution of the sub-routine M₂₂₁ are D₂₁ and D₂₁₁_{_{—}}₁, respectively. The number of pieces of input data and the number of pieces of output data in the first execution of the sub-routine M₂₂₂ are D₂₁₁_{_{—}}₁ and D₂₁₂_{_{—}}₁, respectively. The number of pieces of input data and the number of pieces of output data of the program module M₂₃ are D₂₁₂_{_{—}}₁ and D₂₃, respectively. The number of pieces of input data and the number of pieces of output data in the second execution of the sub-routine M₂₂₁ are D₂₃ and D₂₁₁_{_{—}}₂, respectively. The number of pieces of input data and the number of pieces of output data in the second execution of the sub-routine M₂₂₂ are D₂₁₁_{_{—}}₂ and D₂₁₂_{_{—}}₂, respectively. The number of pieces of input data and the number of pieces of output data of the program module M₂₄ are D₂₁₂_{_{—}}₂ and D₂₄. The load measurement unit 130 can measure loads L₂₁, L₂₂, L₂₃, and L₂₄ of the program modules M₂₁, M₂₂, M₂₃, and M₂₄ based on the numbers of pieces of input and output data as follows.

$$\begin{matrix}[ Math . 2 ] & \\ {L}_{21} = {D}_{21} - {D}_{20} & ( 5 ) \\ \begin{matrix}{L}_{22} = ( {D}_{211 \_ 1} - {D}_{21} ) + ( {D}_{212 \_ 1} - {D}_{211 \_ 1} ) + \\ ( {D}_{211 \_ 2} - {D}_{23} ) + ( {D}_{212 \_ 2} - {D}_{211 \_ 2} ) \\ = ( {D}_{212 \_ 1} - {D}_{21} ) + ( {D}_{212 \_ 2} - {D}_{23} )\end{matrix} & ( 6 ) \\ {L}_{23} = {D}_{23} - {D}_{212 \_ 1} & ( 7 ) \\ {L}_{24} = {D}_{24} - {D}_{212 \_ 2} & ( 8 )\end{matrix}$$

In this way, the loads of the program modules may be measured by summing up differences between the numbers of pieces of output data and input data calculated at the time of the calling for the program modules (or the sub-routines) called a plurality of times.

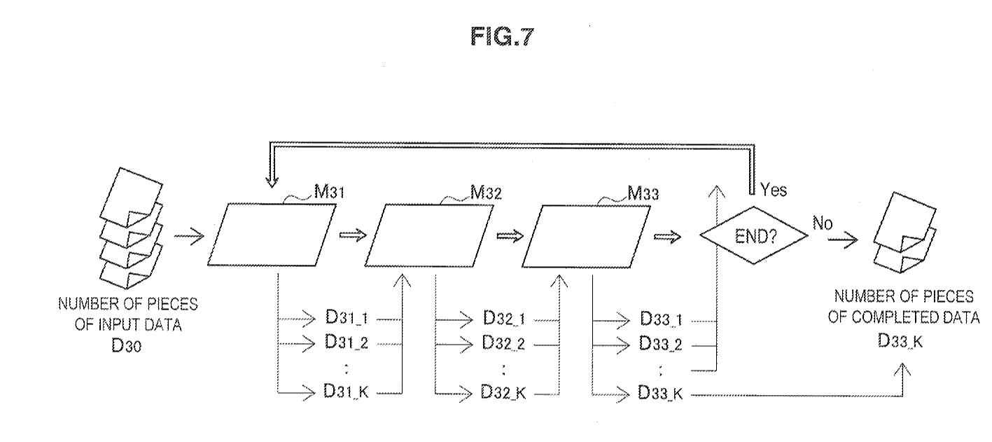

FIG. 7 is an explanatory diagram for describing still another example of the method of measuring the load of each program module. Referring to FIG. 7, three program modules M31, M32, and M33 included in a given application are illustrated. The program modules are repeatedly called until a given ending condition is satisfied. The number of pieces of input data and the number of pieces of output data in the first execution of the program module M₃₁ are D₃₀ and D₃₁_{_{—}}₁, respectively. The number of pieces of input data and the number of pieces of output data in a k^{th} execution the program module M₃₁ after the second time are D₃₃_{_{—}}₍ₖ₋₁₎ and D₃₁_{_{—}}ₖ, respectively. The number of pieces of input data and the number of pieces of output data in the k^{th} execution the program module M₃₂ are D₃₁_{_{—}}ₖ and D₃₂_{_{—}}ₖ, respectively. The number of pieces of input data and the number of pieces of output data in the k^{th} execution the program module M₃₃ are D₃₂_{_{—}}ₖ and D₃₃_{_{—}}ₖ, respectively. The load measurement unit 130 can measure loads L₃₁, L₃₂, and L₃₃ of the program modules M₃₁, M₃₂, and M₃₃ based on the numbers of pieces of input and output data as follows.

$$\begin{matrix}[ Math . 3 ] & \\ {L}_{31} = ( {D}_{31 \_ 1} - {D}_{30} ) + {\sum }_{k = 2}^{K} ( {D}_{31 \_ k} - {D}_{33 \_ ( k - 1 )} ) & ( 9 ) \\ {L}_{32} = {\sum }_{k = 1}^{K} ( {D}_{32 \_ k} - {D}_{31 \_ k} ) & ( 10 ) \\ {L}_{33} = {\sum }_{k = 1}^{K} ( {D}_{33 \_ k} - {D}_{32 \_ k} ) & ( 11 )\end{matrix}$$

In formula (9) to formula (11), K indicates a number of repetitions.

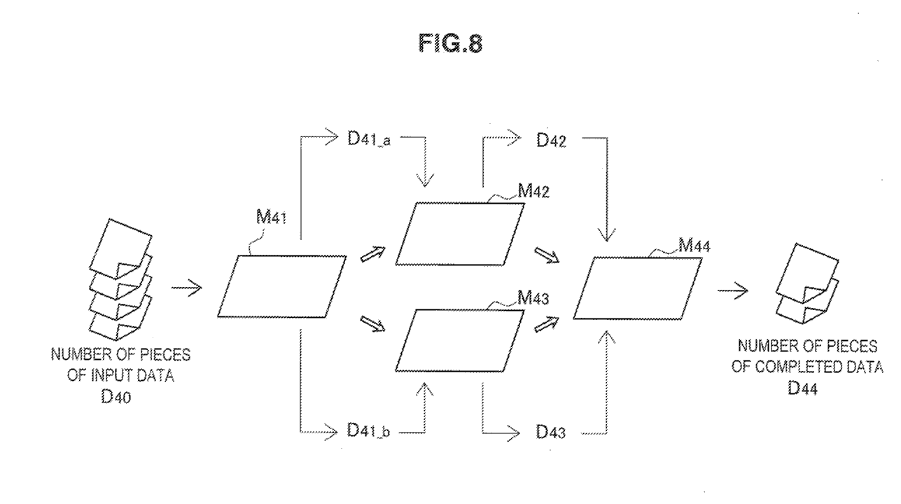

FIG. 8 is an explanatory diagram for describing further still another example of the method of measuring the load of each program module. Referring to FIG. 8, four program modules M₄₁, M₄₂, M₄₃, and M₄₄ included in a given application are illustrated. The program modules M₄₂ and M₄₃ are divided in parallel from the program module M₄₁ and call the program module M₄₄ together. The number of pieces of input data of the program module M₄₁ is D₄₀, the number of pieces of output data to the program module M₄₂ is D₄₁_{_{—}}ₐ, and the number of pieces of output data to the program module M₄₃ is D₄₁_{_{—}}_{b}. The number of pieces of input data and the number of pieces of output data of the program module M₄₂ are D₄₁_{_{—}}ₐ and D₄₂, respectively. The number of pieces of input data and the number of pieces of output data of the program module M₄₃ are D₄₁_{_{—}}_{b} and D₄₃, respectively. The number of pieces of input data of the program module M₄₄ from the program module M₄₂ is D₄₂, the number of pieces of input data from the program module M₄₃ is D₄₃, and the number of pieces of output data is D₄₄. The load measurement unit 130 can measure the loads L₄₁, L₄₂, L₄₃, and L₄₄ of the program modules M₄₁, M₄₂, M₄₃, and M₄₄ based on the numbers of pieces of input and output data as follows.

[Math. 4]

L₄₁=(D₄₁_{_{—}}ₐ+D₄₁_{_{—}}_{b})−D₄₀ (12)

L₄₂=D₄₂−D₄₁_{_{—}}ₐ (13)

L₄₃=D₄₃−D₄₁_{_{—}}_{b} (14)

L₄₄=D₄₄−(D₄₁_{_{—}}ₐ+D₄₁_{_{—}}_{b}) (15)

These methods of measuring the loads approximately may be combined in any manner according to a program structure.

### [2-2. Flow of Processes]

### (1) Overall Flow

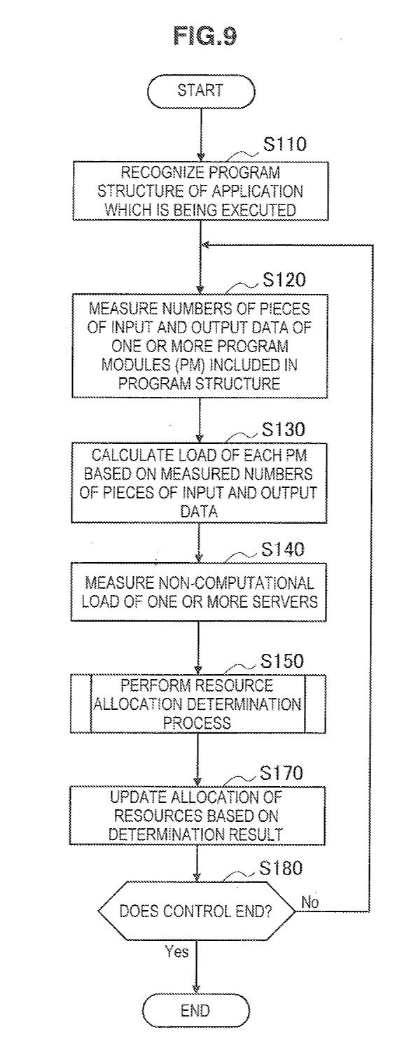

FIG. 9 is a flowchart illustrating an example of flow of a resource control process executed by the information processing apparatus 100 according to the embodiment.

Referring to FIG. 9, the load measurement unit 130 first recognizes the program structure of an application which is being executed by the computing system 10, referring to the program structure data stored by the program structure DB 110 (step S110).

Next, the load measurement unit 130 measures the number of pieces of input data and the number of pieces of output data of one or more program modules included in the recognized program structure (step S120). Then, the load measurement unit 130 computes the load of each program module based on the measured number of pieces of input data and the measured number of pieces of output data (step S130).

Also, the load measurement unit 130 measures the non-computational load (for example, a memory load, an I/O load, or a communication load) of one or more servers allocated to the application which is being executed, referring to the resource structure DB 120 (step S140).

Next, the determination unit 140 executes a resource allocation determination process based on the measurement result of the loads executed by the load measurement unit 130 (step S150). Thus, new allocation of the resources can be determined.

Next, the resource control unit 150 changes the allocation of the resources by transmitting a control signal to the computing system 10 with regard to the program module for which the number of allocated processes or the number of allocated servers is determined to be changed (step S170). The allocation of the new resources is stored by the resource structure DB 120.

Typically, the above-described processes can be repeated periodically until the execution of the application ends (step S180). When the execution of the application ends, the resource control process of FIG. 9 ends.

### (2) Resource Allocation Determination Process

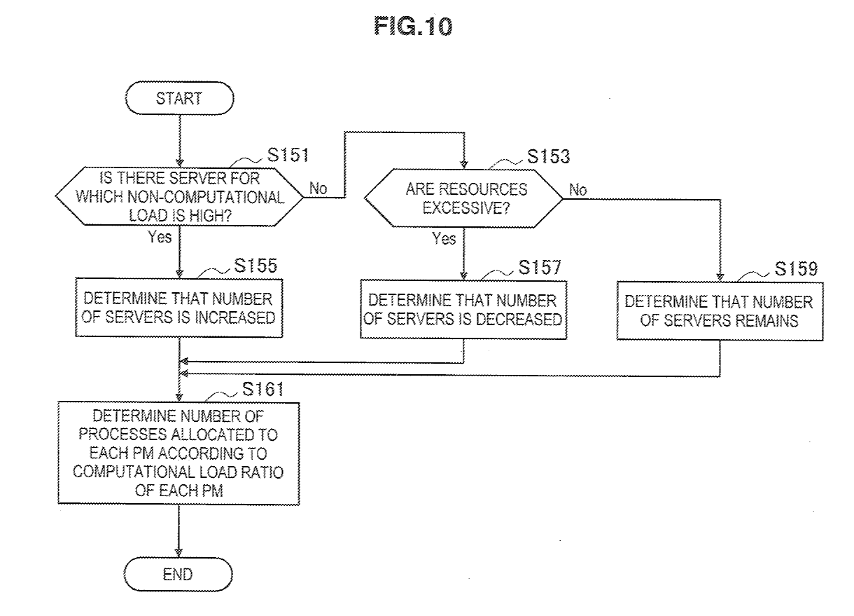

FIG. 10 is a flowchart illustrating an example of detailed flow of the resource allocation determination process illustrated in FIG. 9.

The process of FIG. 10 is divided based on the measurement result of the loads input from the load measurement unit 130 to the determination unit 140. First, when there is a server for which the non-computational load is high, the process proceeds to step S155 (step S151). When there is no server for which the non-computational load is high and the resources are excessive (for example, there is no program module for which the computational load is greater than a predetermined threshold value and the non-computational load is also less than a predetermined threshold value), the process proceeds to step S157. When the process does not correspond to any case, the process proceeds to step S159.

In step S155, the determination unit 140 determines that the number of servers is increased. In step S157, the determination unit 140 determines that the number of servers is decreased (excluding a case in which the number of servers is already one). In step S159, the determination unit 140 determines that the number of servers remains.

Next, the determination unit 140 determines the number of processes allocated to each program module according to the computational load ratio of each program module (step S161). As a result, for the program module indicating a high computational load, an additional process in the allocated server or a process in the new server can be allocated.

### 3. Second Embodiment

In the first embodiment, the processing resources are dynamically changed by monitoring the load of each program module. Under a condition in which the number of requests to an application is gently changed, the resource structure can be optimized by a so-called feedback type control method. However, under a condition in which the change in the number of requests to an application is not gentle, there is a probability of the feedback type control method not following the change in the number of requests. In this case, it is advantageous to predict an increase in a load from the number of requests and change the resource structure before occurrence of an actual load in order to ensure desired performance of an application. Accordingly, in a second embodiment, a structure in which necessary scale (for example, the number of necessary processes) of processing resources is predicted based on the number of requests to an application and the necessary processing resources are allocated to a program module before an increase in an actual load will be described.

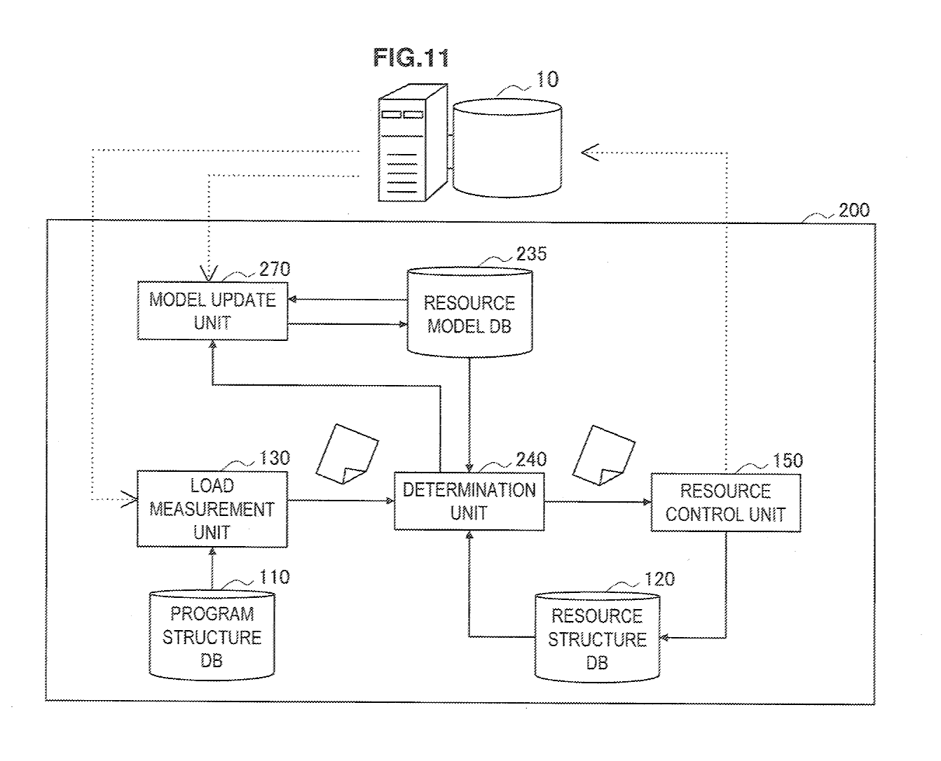

FIG. 11 is a block diagram illustrating an example of the configuration of an information processing apparatus 200 according to the second embodiment. Referring to FIG. 11, the information processing apparatus 200 includes a program structure DB 110, a resource structure DB 120, a load measurement unit 130, a resource model DB 235, a determination unit 240, a resource control unit 150, and a model update unit 270.

### (1) Resource Model DB

The resource model DB 235 is a database that stores a resource model expressing a relation between the number of requests and a necessary scale of processing resources in advance with regard to each application executed by the computing system 10. The necessary scale of the processing resources may be, for example, a lower limit of the number of processes by which application processing can be completed for a given number of requests under the condition that a predetermined performance requirement be satisfied. The predetermined performance requirement may be any requirement such as an upper limit of a total execution time of application processing, an upper limit of an execution time of each program module, an available maximum number of servers, or a specific communication environment.

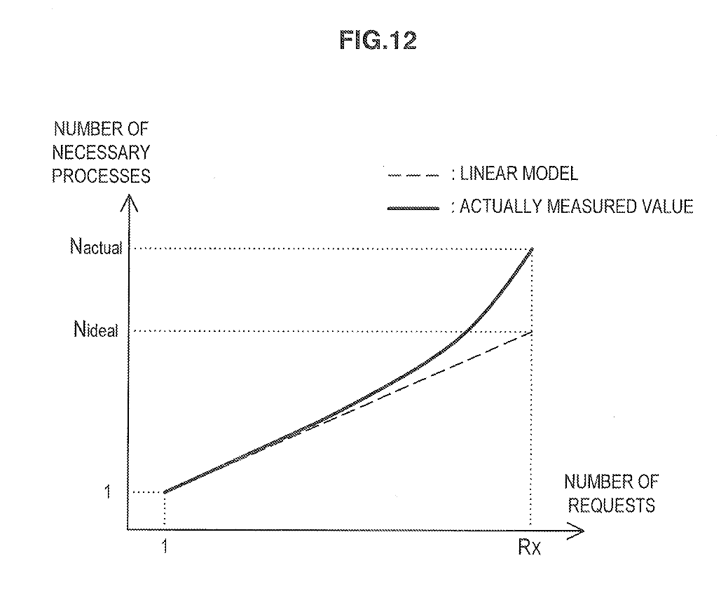

FIG. 12 is an explanatory diagram for describing a resource model expressing a relation between the number of requests to an application and necessary scale of the resources. In the example of FIG. 12, the horizontal axis represents the number of requests and the vertical axis represents the number of necessary processes. A dotted line in FIG. 12 indicates a linear model in which an increase in the number of necessary processes is proportional to an increase in the number of requests. However, when the number of necessary processes is actually measured using a computer and the relation between the number of requests and the number of necessary processes is plotted, the plotted line does not depict an ideal straight line. In practice, as in the curve indicated by a solid line in FIG. 12, the larger the number of requests is, the higher a ratio of the increase in the number of necessary processes to the increase in the number of requests is (a slope of the model in FIG. 12). For example, the curve of the resource model can be acquired in advance for each application or each program module included in the application by a regression analysis using a plurality of pairs of the number of requests to the application and actually measured values of the corresponding necessary scale (for example, under an experiment environment). The resource model DB 235 stores the acquired resource models as data.

### (2) Determination Unit

The determination unit 240 acquires the number of requests to an application which is being executed from the computing system 10 and determines whether the number of processes allocated to each program module is changed based on the resource model stored in the resource model DB 235 and the acquired number of requests. Also, the determination unit 240 determines the changed number of processes when the number of processes is changed. The determination unit 240 may determine (correct) the number of processes based on the latest load when the load measured by the load measurement unit 130 is determined not to be reduced with the number of processes determined from the resource model. Also the determination unit 240 further determines whether the number of servers allocated to each program module is changed based on the non-computational load measured for each server. As in the first embodiment, the number of processes allocated to each program module may be changed along with the change in the number of servers or may be changed without the change in the number of servers. The resource control unit 150 changes one or both of the number of processes and the number of servers allocated to each program module according to the determination result input from the determination unit 240.

### (3) Model Update Unit

The model update unit 270 updates the resource model stored by the resource model DB 235 while executing the application based on a new pair of the number of requests acquired from the computing system 10 and the corresponding necessary scale. For example, when the allocation of the number of processes is corrected based on the latest value of the load in the determination unit 240 (from the predicted value based on the resource model), the model update unit 270 can update the resource model by incorporating a new pair of the number of requests and the corrected number of processes into the regression analysis. By elaborating the resource model through the dynamic updating of the resource model, the prediction accuracy of the necessary scale is improved. Accordingly, by following the allocation of the processing resources rapidly to the change in the number of requests even under conditions in which the number of requests is dramatically changed, it is possible to prevent the performance of the application from deteriorating even temporarily.

### 4. Conclusion

Several embodiments of the technology related to the present disclosure have been described in detail above with reference to FIGS. 1 to 12. According to the above-described embodiments, the processing resources allocated to each program module are dynamically changed in units of processes based on the measurement result of the load of each program module when an application is executed using the scalable processing resources. Accordingly, unlike the resource control in units of servers, it is possible to prevent various resources other than the processing resources from being unnecessarily allocated to the application. Accordingly, it is possible to efficiently utilize the resources compared to the existing methods.

According to the above-described embodiments, the number of pieces of input data which is being processed can be measured as a load of each program module. Accordingly, even in a cloud computing environment in which it is difficult to directly measure how many loads are provided to which processor when a certain program module is executed, the load of the processing resources can be approximately measured and the measured approximate load can be utilized to control the resources in units of processes.

According to the above-described embodiments, the scale of the processing resources is controlled based on at least the number of servers and the number of processes of each server. Additionally, it can be determined whether the number of servers allocated to each program module is changed based on the non-computational load measured for each application or each server. Thus, the allocation of the proper kinds of resources (servers/processes) can be controlled according to a cause increasing a load. Accordingly, the more efficient use of the resources is realized.

According to the above-described embodiments, the scale of the processing resources can be controlled in units of processes according to the resource model expressing the relation between the number of requests to the application and the necessary scale of the processing resources. In this case, unlike a pure feedback type control method based on the actually measured values of loads, it is possible to prevent a predicted increase in the load in advance. Accordingly, even under the condition in which the number of requests is changed, it is possible to ensure desired performance of the application.

A series of processes executed by the information processing apparatus described in this specification is realized typically using software. A program of the software realizing the series of processes is stored in advance in, for example, a storage medium (a non-transitory medium) installed inside or outside the information processing apparatus. Then, for example, each program is read to a RAM at the time of execution and is executed by a processor such as a CPU or the like.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a determination unit that determines whether to change a number of processes allocated to one or more program modules, based on a measurement result of a load of each program module when the program modules that form an application are executed using scalable processing resources.

(2) The information processing apparatus according to (1), further including:

a resource control unit that changes the number of allocated processes with regard to each program module for which the determination unit has determined that the number of allocated processes is to be changed.

(3) The information processing apparatus according to (2), further including:

a measurement unit that measures the load of each program module.

(4) The information processing apparatus according to (3), wherein the measurement unit measures a number of pieces of input data which is being processed, as the load of each program module.

(5) The information processing apparatus according to (4),

wherein scale of the processing resources is controlled based on at least a number of servers and a number of processes of each server, and

wherein the determination unit further determines whether to change the number of servers allocated to each program module, based on a non-computational load measured for each application or each server.

(6) The information processing apparatus according to (5), wherein, in a case where the determination unit determines that the number of processes allocated to each program module is to be increased, the determination unit determines that the number of servers allocated to each program module is to be increased when the non-computational load is greater than a threshold value, and determines that the number of servers allocated to each program module is to be maintained and the number of processes is to be increased when the non-computational load is less than the threshold value.

(7) The information processing apparatus according to any one of (4) to (6), wherein the resource control unit allocates a greater number of processes to each program module indicating a high ratio of the number of pieces of input data which is being processed.

(8) The information processing apparatus according to (5) or (6), wherein the non-computational load includes at least one of a memory load, an I/O load, and a communication load.

(9) The information processing apparatus according to any one of (2) to (8), wherein the resource control unit controls scale of the processing resources according to a number of requests to the application in a resource model expressing a relation between the number of requests to the application and necessary scale of the processing resources.

(10) The information processing apparatus according to (9), wherein the resource model is acquired in advance by a regression analysis using a plurality of pairs of the number of requests and corresponding necessary scale.

(11) The information processing apparatus according to (10), further including:

a model update unit that updates the resource model based on a new pair of the number of requests and the corresponding necessary scale while executing the application.

(12) A resource control method executed by an information processing apparatus, the resource control method including:

determining whether to change a number of processes allocated to one or more program modules, based on a measurement result of a load of each program module when the program modules that form an application are executed using scalable processing resources.

(13) A program for causing a computer that controls an information processing apparatus to function as:

a determination unit that determines whether to change a number of processes allocated to one or more program modules, based on a measurement result of a load of each program module when the program modules that form an application are executed using scalable processing resources.

What is claimed is:

1. An information processing apparatus comprising:
a determination unit that determines whether to change a number of processes allocated to one or more program modules, based on a measurement result of a load of each program module when the program modules that form an application are executed using scalable processing resources.

2. The information processing apparatus according to claim 1, further comprising:
a resource control unit that changes the number of allocated processes with regard to each program module for which the determination unit has determined that the number of allocated processes is to be changed.

3. The information processing apparatus according to claim 2, further comprising:
a measurement unit that measures the load of each program module.

4. The information processing apparatus according to claim 3, wherein the measurement unit measures a number of pieces of input data which is being processed, as the load of each program module.

5. The information processing apparatus according to claim 4,
wherein scale of the processing resources is controlled based on at least a number of servers and a number of processes of each server, and
wherein the determination unit further determines whether to change the number of servers allocated to each program module, based on a non-computational load measured for each application or each server.

6. The information processing apparatus according to claim 5, wherein, in a case where the determination unit determines that the number of processes allocated to each program module is to be increased, the determination unit determines that the number of servers allocated to each program module is to be increased when the non-computational load is greater than a threshold value, and determines that the number of servers allocated to each program module is to be maintained and the number of processes is to be increased when the non-computational load is less than the threshold value.

7. The information processing apparatus according to claim 4, wherein the resource control unit allocates a greater number of processes to each program module indicating a high ratio of the number of pieces of input data which is being processed.

8. The information processing apparatus according to claim 5, wherein the non-computational load includes at least one of a memory load, an I/O load, and a communication load.

9. The information processing apparatus according to claim 2, wherein the resource control unit controls scale of the processing resources according to a number of requests to the application in a resource model expressing a relation between the number of requests to the application and necessary scale of the processing resources.

10. The information processing apparatus according to claim 9, wherein the resource model is acquired in advance by a regression analysis using a plurality of pairs of the number of requests and corresponding necessary scale.

11. The information processing apparatus according to claim 10, further comprising:
a model update unit that updates the resource model based on a new pair of the number of requests and the corresponding necessary scale while executing the application.

12. A resource control method executed by an information processing apparatus, the resource control method comprising:
determining whether to change a number of processes allocated to one or more program modules, based on a measurement result of a load of each program module when the program modules that form an application are executed using scalable processing resources.

13. A program for causing a computer that controls an information processing apparatus to function as:
a determination unit that determines whether to change a number of processes allocated to one or more program modules, based on a measurement result of a load of each program module when the program modules that form an application are executed using scalable processing resources.
